(19) United States
(12) Patent Application Publication
(10) Pub. No.: US 2013/0244850 A1
(43) Pub. Date: Sep. 19, 2013

(54) METHOD OF PRODUCING A PACKAGING MATERIAL PROVIDED WITH A RECURRING PATTERN OF PRINT INK

(71) Applicant: Mats Aldén, Munka Ljungby (SE)

(72) Inventor: Mats Aldén, Munka Ljungby (SE)

(73) Assignee: Tetra Laval Holdings & Finance S.A., Pully (CH)

(21) Appl. No.: 13/988,672

(22) PCT Filed: Nov. 8, 2011
(86) PCT No.: PCT/SE2011/051330

§ 371 Date: May 21, 2013

(30) Foreign Application Priority Data
Dec. 29, 2010 (SE) 1001234-2

(51) Int. Cl. B31F 7/00

(52) U.S. Cl. CPC B31F 7/00
USPC 493/320

(57) ABSTRACT

A method of producing a packaging material in which a web of paper is provided with a pattern of printing ink at the same time as the web is subjected to a mechanical processing by means of which the areas of the web provided with printing ink are compressed to such an extent that the printing ink throughout within these compressed areas is located on a level flush with or below the level of the remaining areas of the web. As a result of the mechanical processing, it will be ensured that the printing ink is prevented from coming into contact with and giving undesirable impressions against the web in immediately preceding winding turns.

### TECHNICAL FIELD

The present invention relates to a method of producing a packaging material in which a web of paper or paperboard is provided with a recurring pattern of printing ink which is printed direct on the paper or paperboard surface of the web, whereafter the web is rolled up for further processing and handling.

### BACKGROUND ART

Within the packaging industry, use is often made of consumer packages of a single-use disposable nature in order to pack and transport liquid foods, such as milk. The packaging material for these so-called single-use packages normally comprises a rigid, but foldable layer of paper or paperboard and outer, liquid-tight coatings of plastic, preferably polyethylene. In order to make for transport and storage of juice and similar oxygen gas-sensitive foods, the packaging material is supplemented with at least one additional layer of a material possessing the requisite gas tightness properties. One common example of such a layer possessing gas tightness properties is an aluminium foil (Alifoil) which moreover affords the advantageous property that it renders the packaging material sealable by induction heat sealing (IH sealing) which is a both rapid, simple and efficient sealing method.

From the packaging material, single-use packages are produced in a per se known manner with the aid of modern packing and filling machines which, either from a web or from individual sheets of the packaging material, form, fill and seal finished packages.

From, for example, a web finished packages are produced in that the web is first reformed into a tube by both longitudinal edges of the web being united to one another in a durable, liquid-tight sealing joint (overlap joint). The tube is filled with the relevant food, e.g. milk, and is divided into continuous, cushion-shaped packaging units by repeated transverse seals of the tube below the level of contents of the tube. The cushion-shaped packaging units are separated from one another by incisions or cuts in the transverse sealing joints and are given the desired geometric configuration, normally parallelepipedic, by fold forming and sealing.

The requirement placed on consumer packages of the above-outlined type is naturally that they must afford the best possible mechanical as well as chemical protection to the packed food. Further, the packages must be easy to open and otherwise convenient to handle for the consumer, and moreover be well-shaped and have an aesthetically attractive appearance.

The requirement of the best possible product protection is satisfied by a suitable combination of individual material layers included in the packaging material which, in cooperation with one another, are intended to afford to the packed product the requisite mechanical as well as chemical protection as long as the food is stored in the unopened package. The openability of the package is ensured normally in that the packages provided with a separate opening arrangement with the aid of which the package may readily be opened every time the package is to be emptied of its contents.

The attractive appearance and configuration of the package are catered for in that the packaging material, already in connection with its production, is provided with the desired pattern of printing ink which may be of the desired decorative as well as informative nature. Correspondingly, the requirement on the desired configuration of the package is satisfied in that the packaging material, similarly in connection with its production, is provided with a suitable pattern of crease lines which facilitate folding in order to make for the fold formation of the packaging material in connection with the production of packages.

A packaging material of the above-described type is produced in a per se known manner in that a web of paper or paperboard is unwound from a magazine reel and led through a first processing station in which the web is provided with a recurring pattern of printing ink which is printed direct on the paper or paperboard surface of the web. As was mentioned earlier, this pattern of printing ink may be of a both decorative and informative nature. In the former case, the pattern is normally composed of a plurality of different inks which are printed in sequence after one another, and in the latter case, the printed pattern most generally consists of but a single ink which is printed in the form of an optically or otherwise detectable marking of optional size and configuration at recurring suitable places on the paper or paperboard surface of the web.

In this context, the term printing ink is taken to signify a dispersion or similar printable composition of pigment, adhesive or binder and solvent. Such dispersions or compositions are commercially available and are not therefore likely to need any detailed description here. For more detailed information on them, reference is instead made to available technical literature in the art.

From the first processing station, the thus printed web is preferably led further to a second processing station in which the web is provided with a recurring pattern of crease lines which facilitate folding and along which the finished packaging material is intended to be folded when the web is reformed into finished packages, as described above. The pattern of crease lines may, in a per se known manner, include both longitudinal and transverse crease lines, depending upon the desired packaging configuration.

In order to ensure the best possible packaging appearance, it is important that the pattern of crease lines be applied in register with the previously printed pattern of printing ink so that the pattern of printing ink of the package, after the fold forming of the packaging material, constantly arrives in the correct position in relation to the folded edge lines and corners of the package.

In order to ensure that the pattern of crease lines is applied in register with the pattern of printing ink, use is preferably made of an optically or otherwise detectable marking of printing ink which is printed on the web in the form of a guide mark which is detected by means of suitable detector device. The signal from this device is transmitted to a central monitoring and control unit which compares the signal with a norm signal and which, in the event of deviations from the norm signal, emits a correction signal by means of which the position of the web is corrected.

From the second processing station, the web is led further for rolling up before further processing. Examples of such additional working operations may be extrusion of plastic layers, film lamination and mechanical corrections to the web.

In the prior art method, it not seldom happens that parts of the pattern of printing ink on rolling up of the web make smudge impressions against the opposing, non-printed surface of the web on the immediately preceding rolling up turn of the web. Such undesired impressions against the non-printed surface of the web normally result in the pattern of printing ink not only losing sharpness and contrast, but may even be so extensive that they cause discolouration and other serious harm to the appearance of the package. The problem with undesirable impressions become particularly aggravated when a printed mark of the printing ink is to be used as a guide mark for controlling the web, as described above. In order to be able to function efficiently and appropriately, such a printed guide mark must display a predetermined geometric shape and size, at the same time as it must be able to be detected and distinguished from adjacent sections of the web. Every impression on a non-printed surface of the web on winding up increases the risk that the printed guide mark will be weakened or distorted so that it can no longer be employed for its intended purpose.

There is thus a need in the art for a method of the type described by way of introduction which makes for the production of a packaging material without accompanying problems and drawbacks of the type associated with the prior art technology.

### OBJECTS OF THE INVENTION

One object of the present invention is therefore to satisfy this need.

Another object of the present invention is to realise a method of producing a packaging material without accompanying problems and drawbacks of the type which are associated with the prior art technology.

These and other objects and advantages will be attained according to the present invention in that the method described by way of introduction has been given the characterising features as set forth in appended Claim 1.

Preferred practical embodiments of the method according to the present invention have further been given the characterising features as set forth in appended subclaims 2 to 13.

### BRIEF SUMMARY OF THE INVENTION

The invention thus realises a method of producing a packaging material in which a web of paper or paperboard is provided with a recurring pattern of printing ink which is printed direct on the paper or paperboard surface of the web, whereafter the web is wound up for further processing and handling. The method according to the present invention is characterised in that the web of paper or paperboard is, before winding up, subjected to a mechanical processing by means of which selected areas of the coarse paper or paperboard surface of the web are flattened out in such a manner and to such an extent that the printed pattern of printing ink, throughout these flattened areas, is located flush with or below the level of the remaining areas of the paper or paperboard surface of the web.

Given that the pattern of printing ink, in the method according to the present invention, is constantly held at a level which on no occasion rises above the level of the adjacent, non-processed areas of the surface of the web, it will thus be ensured that the printed pattern, on rolling up of the web, is constantly concealed or protected against direct contact with the opposing, non-printed surface of the immediately preceding winding up turn of the web.

In one embodiment of the method according to the present invention, the web is subjected to the mechanical processing before or in connection with application of the recurring pattern of printing ink which is printed direct on the paper or paperboard surface of the web within the selective areas flattened by the mechanical processing.

The mechanical processing of the web may be carried out in a variety of different known ways, for example by mechanical grinding away of fibre material, but is preferably carried into effect by a mechanical compression with simultaneous reduction of the thickness of the web.

In another embodiment of the method according to the present invention, the web is subjected to the mechanical processing after application of the recurring pattern of printing ink, the printed areas of the web being flattened to such an extent that the printed pattern of printing ink throughout these flattened areas is located flush with or below the level of the remaining areas of the paper or paperboard surface of the web.

The mechanical processing of the web may be put into effect in a variety of different ways, such as for example by mechanical grinding away of fibre material, but is preferably carried into effect by a mechanical compression with simultaneous reduction of the thickness of the web.

As described above, the paper or paperboard web may, after printing with printing ink, be led through a second processing station in which the web is provided with a recurring pattern of crease lines which facilitate folding in order to facilitate reforming of the web into well-configurated packages by fold forming. In such instance, the web is led through the nip between two rotary rollers, of which the one roller (“the male roller”) is, on its surface, the carrier of linear peripheral projections in a pattern corresponding to the desired pattern of crease lines. The other roller (“the female roller”) may in a corresponding manner have linear peripheral recesses or grooves in register with the linear projections on the male roller in order to accommodate them when the rollers are rotated in mesh with the web which is led through the nip between the rollers, when this is led through the roller nip.

In the method according to the present invention, the mechanical processing of the web, where applicable, for example in the second embodiment above, be combined and carried into effect together with the creasing operation at the second processing station in that one of the two rollers (“the male roller”) is supplemented with an additional pattern of peripheral projections whose positioning, configuration and size correspond to the previously printed pattern of printing ink on the web.

No matter whether the mechanical processing of the web is carried out before, after or in connection with the application of printing ink, the method according to the present invention may be carried into effect using any type of printing ink, such as radiation setting printing ink, heat setting printing ink etc. However, particularly advantageously the method according to the present invention is carried into effect employing printing inks of the type which comprise a combination of solid pigment, binder and solvent, where problems involving impression on rolling up of the web were previously particularly occurrent and manifest. In particular, such impressions have been able to be related to the presence of solid pigment in the printing ink composition employed. Examples of such pigments may be iron oxide, titanium oxide, chromium oxide and cobalt, but also particles such as magnetite and maghemite.

After rolling up, the printed paper web is unrolled for further processing, such as extrusion of outer, liquid-tight plastic layers on both sides of the web and, where necessary, lamination of at least one additional layer of a material possessing superior tightness properties vis-à-vis gases, in particular oxygen gas. Such an additional layer may be a film of EVOH (ethylene vinyl alcohol), PA (polyamide), PET (polyester), but is preferably an Alifoil (aluminium foil) which moreover renders the packaging material sealable by IH sealing (induction heat sealing) which is a rapid and efficient sealing technology.

After one or more additional mechanical repair and correction operations to the web, the packaging material is ready to be reformed into finished packages, as described above.

Further advantageous and practical embodiments of the method according to the present invention will be described in greater detail hereinbelow, with reference to the accompanying Drawings. BRIEF DESCRIPTION OF THE ACCOMPANYING DRAWINGS

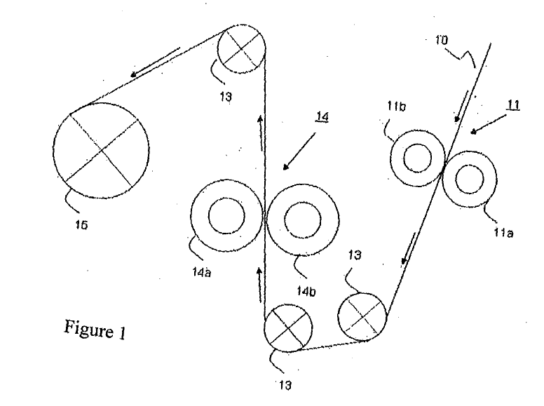

FIG. 1 schematically illustrates the method according to a first embodiment of the present invention;

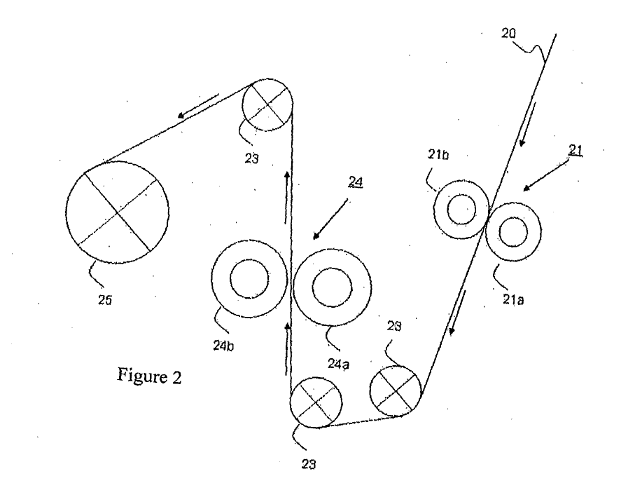

FIG. 2 schematically illustrates the method according to a second embodiment of the present invention;

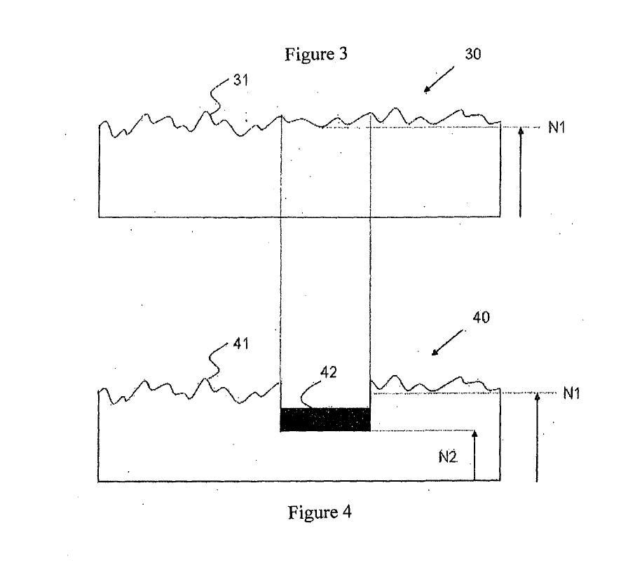

FIG. 3 schematically illustrates a cross section of a paper or paperboard web before mechanical processing in the method according to the present invention; and

FIG. 4 is a schematic cross section of the same paper or paperboard web after mechanical processing in the method according to the present invention.

### DETAILED DESCRIPTION OF THE INVENTION

While the present invention will be described with particular reference to the accompanying Drawings, it should be observed that those embodiments which are illustrated and described are merely intended to illustrated the invention, without restricting it. To a person skilled in the art, it will be obvious that many closely related modifications are possible using the guidance of the description and the accompanying Drawings, without departing from the inventive concept as this is defined in the appended Claims.

In FIG. 1, a web 10 of paper or paperboard is unwound from a magazine reel (not shown) in the upper, right-hand corner of the figure. The web 10 is led in the direction of the arrow through a processing station 11, where the surface of the web 10, along selected areas, is provided with a pattern of printing ink which is printed direct on the paper or paperboard surface of the web 10. In such instance, the web 10 is led between two adjacent rotary rollers 11a, 11b of which the one roller 11a transfers printing ink in the desired pattern to the surface of the paper or paperboard web when the web is led between and in contact with the two rollers 11a, 11b.

The pattern of printing ink which is printed direct on the paper or paperboard surface of the web 10 at the station 11 may be any optional decorative artwork of one or more different colours which is printed on the web 10 in sequence after and in register with one another. In another example, the pattern of printing ink may be a text which is printed employing but a single printing ink. In yet a further example, this pattern may be printed in the form of an optically or otherwise detectable marking displaying a predetermined geometric shape, size and positioning on the web for use as a guide mark for guiding and adjusting the position of the web, as described above.

From the station 11, the printed web 10 is led via bending rollers 13 to an additional processing station 14 where the web 10 is provided, for purposes of facilitating folding, with a recurring pattern of crease lines. The web 10 is at the same time subjected to a mechanical processing through which the web 10 is compressed or flattened to such an extent and at such positions that the level of the previously applied pattern of printing ink, after the mechanical processing, at no point lies above the level of adjacent, non-processed areas of the paper or paperboard surface.

In the mechanical processing at station 14, the web 10 is, in the illustrated embodiment, led through the nip between two closely adjacent rotary rollers 14a, 14b, of which the one roller 14a (“the male roller”) displays on its circumferential surface linear peripheral projections (not shown) in a recurring pattern corresponding to the pattern of crease lines which is to be applied on the web 10. Moreover, the male roller 14a has peripheral printing means in a pattern which corresponds to the pattern of printing ink which has been applied at the earlier processing station 11. The second roller 14b (“the female roller”) may have a corresponding pattern of linear peripheral grooves or recesses (not shown) in order to accommodate the peripheral projections of the male roller 14a when the web 10 is led through the nip between the rollers.

In order to make for the later production of well-formed well-decorated packages, it is, as has already been pointed out, crucial that the pattern of crease lines be applied in register with the pattern of printing ink

From the station 14, the web 10 provided with crease lines and compressed and flattened in selected areas is then led via an additional bending roller 13 for winding up onto a magazine reel 15 for further processing and handling.

In FIG. 2, a web 20 of paper is unwound from a magazine reel (not shown) in the upper, right-hand corner of the figure. The web 20 is led in the direction of the arrow through a processing station 21 where the surface of the web 20 is provided with a recurring pattern of printing ink at the same time as the web 20 is subjected to a mechanical processing with a view to imparting to the web 20 a flattened uniform topography within these areas.

Such a combined compression and processing is catered for, for example, in that the surface of the web 20 is compressed in such a manner that profile peaks in the raw and coarse surface of the paper surface are evened out or eliminated entirely, at the same time as printing ink is printed direct on the surface of the web within these compressed web areas.

Preferably, the mechanical processing or compression of the web 20 is carried out to such an extent that the web 20 is simultaneously reduced in thickness because of the powerful compression.

In the illustrated example, such a compression is carried out with simultaneous reduction of the thickness of the web 20 with the aid of two adjacent rotary rollers 21a, 21b between which the web 20 is caused to pass. The one roller 21a displays peripheral compression means (not shown) at predetermined recurring positions around its circumferential surface, these compression means being disposed to be brought into engagement with the web 20 for compression and flattening of the web 20. At the same time as, or in connection with the mechanical processing, printing ink is applied on the web 20 within these attenuated areas, where the web 20 is led between the two rotary rollers 21a, 21b.

The pattern of printing ink which is printed direct on the paper or paperboard surface of the web 20 at station 21 may be any optional decorative artwork consisting of one or more different inks which are printed on the web 20 in sequence after one another and in register with one another. In another example, the pattern of printing ink may be a text which is printed employing but a single printing ink. In yet a further example, this pattern may be printed as an optically or otherwise detectable marking of a predetermined geometric shape, size and positioning on the web for use as guide mark for controlling and adjusting the position of the web during subsequent working operations on the web.

No matter whether the printed pattern of printing ink on the web 20 is to be employed as decorative artwork, information carrier or guide mark, it is, as was pointed out earlier, crucial that the printed pattern be constantly kept at a level which on no occasion during the further processing of the web, extends up above the level of adjacent, non-processed areas of the surface of the web. In other words, it is crucial that the total volume of printing ink which is printed on the web is not greater than the total available ink absorbing volume created by the compressed, attenuated areas of the web. If the ink absorbing volume is slight, the employed volume of printing ink must thus correspondingly be slight, while the reverse situation applies if the ink absorbing volume is large.

Adjustment and/or correction of the relationship between these two volumes may be put into effect by a simple manual test. A test sample of the web is taken at an optional occasion and divided into two parts. The printed side of the one part is rubbed against the non-printed side of the second part in order to visually assess whether printing ink is transferred and makes an impression on the non-printed side. If an impression is observed, this implies that the printing ink on the printed test sample exceeds the permitted level and must be reduced. Alternatively, the created ink absorbing volume may instead be increased in that the reduction of the thickness of the web is increased in the mechanical processing. By repeated sampling, it may finally be decided when printing ink is employed in an acceptable volume, i.e. when ink impressions are no longer observed during the test.

From the station 21, the thus printed and mechanically processed web 20 is led further via one or more bending rollers 23 (two in number in the illustrated example) to and through one or more additional processing stations which may be employed in the production of the packaging material using the method according to the present invention. In the illustrated embodiment in FIG. 2, the web 20 is thus led to an additional such processing station 24 where the web 20 is provided with a recurring pattern of crease lines in order to facilitate reforming of the web into well-formed packages by fold forming. In the illustrated embodiment, the web 20 is led through the nip between two closely adjacent rotary rollers 24a, 24b of which the one roller 24a (“the male roller”) displays on its circumferential surface linear peripheral projections (not shown) in a recurring pattern corresponding to the pattern of crease lines to the applied on the web 20. The second roller 24b (“the female roller”) correspondingly displays linear peripheral grooves or recesses (not shown) on its circumferential surface in order to accommodate the peripheral projections when the rollers 24a, 24b are rotated in mesh with the web 20.

In order to ensure the best possible packaging appearance when the web 20 of packaging material is reformed into packages, it is, as has already been pointed out, crucial that the pattern of crease lines be applied in register with the previously printed pattern of printing ink, so that the pattern of printing ink is placed in the correct position in relation to the geometric edge lines and corners of the fold-formed package. In order to guide the web 20 so that the pattern of crease lines is applied in register with the pattern of printing ink, use is preferably made of the optically or otherwise detectable pattern of printing ink or parts thereof in the form of a guide mark which is detected with the aid of a suitable detection system which the web is caused to pass. The detected signal is processed in a per se known manner in order, where necessary, to correct the position of the web in view of the processing operation at the station 24 so that the pattern of crease lines is applied in register with the pattern of printing ink.

From the station 24, the web 20 provided with crease lines and printed is thereafter led further via an additional bending roller 23 for winding up onto a magazine reel 25 for further processing and handling, as was mentioned above.

FIG. 3 shows a schematic cross section of a paper or paperboard web of the type employed for the production of a packaging material using the method according to the present invention. In particular, FIG. 3 shows the paper or paperboard web in a stage prior to the mechanical processing, i.e. when the paper or paperboard surface still displays a raw and coarse topography.

As is clearly apparent from the figure, the paper or paperboard web carrying the generic reference numeral 30 displays a raw and coarse surface with an irregular corrugated topography with profile peaks and profile troughs on different vertical levels along an undulating horizontal profile line 31. The horizontal ghosted line N1 marks the lowest level of the coarse paper or paperboard surface, seen in the vertical direction, within an area intended for printing with printing ink, as will be described in greater detail with reference to FIG. 4.

FIG. 4 schematically shows a cross section of the same paper or paperboard web as shown in FIG. 3, but at a stage after printing with printing ink and mechanical processing of the web. In order to make for a comparison between FIG. 3 and FIG. 4, the same reference numerals as in FIG. 3 have been employed for corresponding parts in FIG. 4, but with the FIG. 4 instead of 3 in the first element of the numeral. Thus, the paper or paperboard web in FIG. 4 carries the generic reference 40 and, in the same manner as the illustrated web in FIG. 3, displays a raw and coarse surface with an irregular undulating topography with profile peaks and profile troughs on different vertical levels along an undulating horizontal profile line 41. Thus, in the same manner as in FIG. 3, the horizontal ghosted line N1 marks the lowest level of the paper or paperboard surface in the vertical direction before printing and mechanical processing of the web 40.

The horizontal extent of the area for printing and mechanical processing of the web 30 in FIG. 3 and the area of the web 40 in FIG. 4 printed with printing ink and mechanically processed is shown symbolically between the two ghosted vertical lines in the central parts of each respective figure.

As will be apparent from FIG. 4, the area of the web 40 flattened and compressed by means of mechanical processing is compressed to such an extent that the horizontal surface of the processed area is lowered to a level N2 which lies clearly below the unprocessed level N1. Further, the thus unprocessed area of the web 40 is printed with printing ink up to a level 42 which is constantly located lower than the level of the immediately adjacent non-processed areas of the web.

In the method according to the present invention, regardless of whether the mechanical processing of the paper or paperboard web is carried into effect before, after or in connection with the web being printed with printing ink, it is thus possible to produce a packaging material which can be wound up when necessary without the risk of undesirable impression of printing ink, as is the case in the prior art technology. It should be observed that the method according to the present invention may also be carried into effect with printing and mechanical processing of both sides of the web and that such an application also lies within the scope of the inventive concept as this is defined in the appended Claims.

### INDUSTRIAL APPLICATION

The method according to the present invention is usable for the production of a packaging material in which a web of paper or paperboard, after printing with printing ink on one or both sides of the web, is intended to be wound up onto a magazine reel before further processing and handling of the web. The present invention is particularly applicable in such cases where the surface of the paper or paperboard web is to be printed with printing ink of the type which contains pigment and similar solid particles in combination with binder and solvent.

1. A method of producing a packaging material in which a web of paper or paperboard is provided with a recurring pattern of printing ink which is printed direct on the paper or paperboard surface of the web, whereafter the web is rolled up onto a magazine reel before further processing, wherein the web of paper or paperboard is, prior to winding up onto magazine reel, subjected to a mechanical processing by means of which selected areas of the coarse paper or paperboard surface of the web are flattened in such a manner and to such an extent that the printed pattern of printing ink throughout within these flattened areas is located on a level flush with or below the level of remaining areas of the paper or paperboard surface of the web.

2. The method as claimed in claim 1, wherein the web is subjected to the mechanical processing after application of the recurring pattern of printing ink.

3. The method as claimed in claim 2, wherein the recurring pattern of printing ink is an optically or otherwise detectable mark of a predetermined geometric shape, size and positioning on the web for use as a guide mark for guiding and adjusting the position of the web in subsequent processing of the web.

4. The method as claimed in claim 1, wherein the web provided with printing ink is provided with a recurring pattern of crease lines facilitating folding.

5. The method as claimed in claim 4, wherein the recurring pattern of crease lines is applied in register with the printed pattern of printing ink.

6. The method as claimed in claim 4, wherein the mechanical processing of the web is carried into effect simultaneously as the web is provided with the recurring pattern of crease lines.

7. The method as claimed in claim 1, wherein the mechanical processing of the web is carried into effect in such a manner that the thickness of the web is simultaneously reduced.

8. The method as claimed in claim 1, wherein the web is subjected to the mechanical processing prior to or in connection with the application of the recurring pattern of printing ink.

9. The method as claimed in claim 8, wherein the recurring pattern of printing ink is an optically or otherwise detectable marking with a predetermined geometric shape, size and positioning on the web for use as a guide mark for detecting and guiding the position of the web in subsequent processing of the web.

10. The method as claimed in claim 8, wherein the mechanical processing of the web is carried into effect by compression of the web and simultaneous reduction of the thickness of the web within the compressed areas.

11. The method as claimed in claim 8, wherein the web provided with printing ink and mechanically processed is provided with a recurring pattern of crease lines facilitating folding.

12. The method as claimed in claim 11, wherein the recurring pattern of crease lines is applied in register with the recurring pattern of printing ink.

13. The method as claimed in claim 1, wherein printing ink use is made of a dispersion of solid pigment or colour particles, binder and solvent.
